(19) United States
(12) Patent Application Publication
(10) Pub. No.: US 2023/0126501 A1
(43) Pub. Date: Apr. 27, 2023

(54) ALL-SOLID-STATE BATTERY

(71) Applicant: TDK CORPORATION, Tokyo (JP)

(72) Inventor: Takeo TSUKADA, Tokyo (JP)

(73) Assignee: TDK CORPORATION, Tokyo (JP)

(21) Appl. No.: 17/908,632

(22) PCT Filed: Jan. 6, 2021
(86) PCT No.: PCT/JP2021/000154

§ 371 Date: Sep. 1, 2022

(30) Foreign Application Priority Data
Mar. 6, 2020 (JP) 2020-039384

(51) Int. Cl. H01M 4/583; H01M 4/36

(52) U.S. Cl. CPC H01M 4/583; H01M 4/366; H01M 2004/027

(57) ABSTRACT

An all-solid-state battery having a positive electrode layer including a positive electrode current collector layer and a positive electrode active material layer, a negative electrode layer including a negative electrode current collector layer and a negative electrode active material layer, and a solid electrolyte layer containing a solid electrolyte, and the positive electrode active material layer and the negative electrode active material layer each contain carbon particles having an average interplanar spacing d002 of smaller than 0.342 (nm).

### TECHNICAL FIELD

The present invention relates to an all-solid-state battery.

Priority is claimed on Japanese Patent Application No. 2020-39384, filed Mar. 6, 2020, the content of which is incorporated herein by reference.

### BACKGROUND ART

Recently, in response to the development of portable devices such as personal computers and mobile phones, demands for batteries as power supplies therefore have been significantly increasing. In batteries that are used for such uses, as a medium that transfers ions, liquid electrolytes (electrolytic solutions) such as organic solvents have been thus far in use. In batteries in which such an electrolytic solution is used, there is a possibility that a problem such as the leakage of the electrolytic solution may be caused.

In order to solve such a problem, development of an all-solid-state battery in which a solid electrolyte is used instead of a liquid electrolyte and all of the other elements are also solid is underway. In such an all-solid-state battery, since the electrolyte is solid, there is no concern of liquid leakage, liquid depletion or the like, and a problem of the deterioration of battery performance due to corrosion or the like is less likely to be caused. Particularly, an all-solid-state battery is being actively studied in a variety of circles as a secondary battery easily enabling a high charge and discharge capacity and a high energy density.

However, ordinarily, all-solid-state batteries in which a solid electrolyte is used as an electrolyte still have a problem of a small discharge capacity compared with batteries in which a liquid electrolyte is used. Li₃V₂(PO₄)₃ (hereinafter, LVP323), which is a NASICON-type phosphoric acid-based active material, has a plurality of oxidation-reduction potentials (3.8 V and 1.8 V), and, in a symmetric electrode battery in which LVP323 is used for the positive electrode and the negative electrode, 2 V-class all-solid-state batteries can be obtained. However, this LVP323 has a problem in that, compared with a case where LiCoO₂ is used as an active material, the electron conductivity is low, the internal resistance of a battery becomes high, and the discharge capacity becomes small. Therefore, in order to improve this electron conductivity, a plurality of conductive bodies orientated almost perpendicularly to a lamination direction is included in an electrode layer or a current collector layer, thereby increasing the electron conductivity in the surface direction in the electrode layer or the current collector layer. In particular, current collectors that are subjected to firing contain carbon due to a concern of the oxidation of metal (Patent Document 1).

### CITATION LIST

### Patent Literature

### [Patent Document 1]

### Japanese Patent No. 5804208

### SUMMARY OF INVENTION

### Technical Problem

However, there is a demand for an additional decrease in the internal resistance of an all-solid-state battery. Therefore, even in the all-solid-state battery disclosed in Patent Document 1, there is still room for improvement in discharge capacity.

The present invention has been made in consideration of such problems of the related art, and an objective of the present invention is to provide an all-solid-state battery in which the internal resistance is further decreased.

### Solution to Problem

As a result of intensive studies for achieving the above-described objective, the present inventors found that, in an all-solid-state battery having a solid electrolyte layer between a pair of electrodes, when carbon particles having an average interplanar spacing d002 of smaller than 0.342 (nm) are used in a positive electrode active material layer and a negative electrode active material layer, it is possible to decrease the internal resistance of the battery by adding a small amount of the carbon particles and completed the present invention.

That is, according to the present invention, all-solid-state batteries to be described below are provided.

An all-solid-state battery according to an aspect of the present invention has a positive electrode layer including a positive electrode current collector layer and a positive electrode active material layer, a negative electrode layer including a negative electrode current collector layer and a negative electrode active material layer, and a solid electrolyte layer containing a solid electrolyte, and the positive electrode active material layer and the negative electrode active material layer contain carbon particles having an average interplanar spacing d002 of smaller than 0.342 (nm).

According to such a configuration, it is possible to decrease the internal resistance of the all-solid-state battery. The carbon particles having an average interplanar spacing d002 of smaller than 0.342 (nm) have favorable crystallinity as a graphite structure and cause periodic disarray to a small extent and thereby have high thermal stability and can be easily left in electrodes even in the case of using a process involving after a heat treatment such as sintering. Therefore, a small amount of the carbon particles added make it possible to obtain a high electron conductivity and to realize a high-density electrode. Furthermore, these carbon particles have high crystallinity and thus have a high electron conductivity. Therefore, when an electrode is formed by mixing these carbon particles and an active material, it was possible to increase the electron conductivity of the electrode by adding a small amount of the carbon particles and to decrease the internal resistance of an all-solid-state battery.

In addition, a small number of pores may be generated in the vicinities of the carbon particles due to the evaporation of carbon during the heat treatment or the like.

In the all-solid-state battery according to an aspect of the present invention, for the carbon particles, in a case where a major axis of the carbon particle is indicated by a, and a minor axis is indicated by b, a ratio thereof may be 1.0<a/b.

According to such a configuration, the use of the carbon particles having small shape anisotropy makes it possible to densely fill an active material with the carbon particles together with active material particles and increases the contact area with the active material, which enables smooth electron transfer. Therefore, it is possible to increase the electron conductivity in the electrodes and to decrease the internal resistance of the all-solid-state battery.

In the all-solid-state battery according to an aspect of the present invention, in a particle size distribution of the carbon particles, D10 may be 0.1 μm or more and D90 may be 5.0 μm or less.

According to such a configuration, it is possible to appropriately bring the carbon particles into contact with the amount of the active material, and, furthermore, the carbon particles can be brought into contact with the active material without generating pores between the active material and the carbon particle, and thus it becomes possible to smoothly exchange electrons, and the internal resistance of the all-solid-state battery can be decreased. In addition, in a case where fine particles having D10 of less than 0.1 μm are included, the carbon particles are easily evaporated during a process such as a heat treatment, and a sufficient effect cannot be obtained.

In the all-solid-state battery according to an aspect of the present invention, the positive electrode active material layer and the negative electrode active material layer may each contain 0.5 (wt %) or more and 15.0 (wt %) or less of the carbon particles.

In the content of the carbon atoms with such a configuration, the carbon particles sufficiently come into contact with each other, the electron conductivity as the electrode can be increased, and it becomes possible to suppress a substantial decrease in the amount of the active material, and thus a high capacity can be obtained while the internal resistance of the all-solid-state battery is decreased.

### Advantageous Effects of Invention

According to the present invention, it is possible to provide an all-solid-state battery having a decreased internal resistance.

### BRIEF DESCRIPTION OF DRAWING

FIG. 1 is a cross-sectional view of an all-solid-state battery of the present embodiment.

### DESCRIPTION OF EMBODIMENTS

Hereinafter, a preferable embodiment of the present invention will be described in detail with reference to the drawing. In the drawing, the same or equivalent portions will be given the same reference sign and will not be described again. In addition, the dimensional ratios in the drawing are not limited to the ratios shown in the drawing. In the drawing to be used in the following description, there is a case where a characteristic portion is shown in an enlarged manner for convenience in order to facilitate the understanding of the characteristics of the present invention. Therefore, the dimensional ratios and the like of each configuration element shown in the drawing are different from actual ones in some cases. Materials, dimensions, shapes and the like provided in the following description are simply exemplary examples, and the present invention is not limited thereto and can be appropriately modified and carried out as long as the gist of the present invention is not changed and the effect of the present invention is exhibited. For example, it is possible to carry out an appropriate combination of configurations described in different embodiments or configurations described in examples. In the present embodiment, there is a case where one direction in a lamination direction is referred to as an upward direction and a downward direction, and “upward” and “downward” mentioned herein do not always coincide with a direction along which the force of gravity is applied.

### (All-Solid-State Battery)

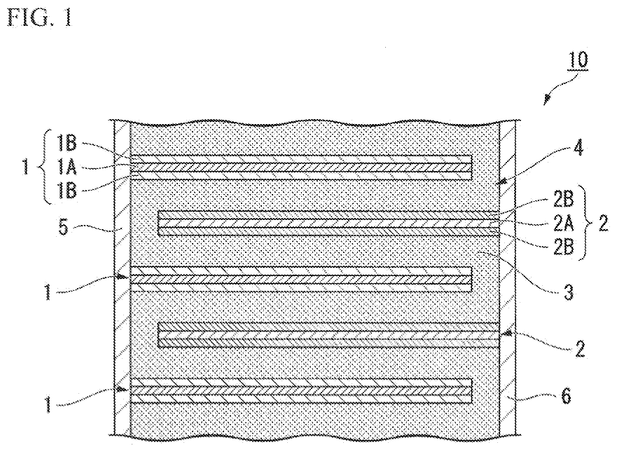

FIG. 1 is a schematic cross-sectional view showing a structure for describing the concept of an all-solid-state battery 10 of the present embodiment. As shown in FIG. 1, the all-solid-state battery 10 of the present embodiment has at least one positive electrode layer 1, at least one negative electrode 2 and a solid electrolyte layer 3 at least partially sandwiched by the positive electrode layer 1 and the negative electrode layer 2. The positive electrode layers 1, the solid electrolyte layers 3 and the negative electrode layers 2 are laminated in order to configure a laminate 4. The positive electrode layers 1 are each connected to a terminal electrode 5 disposed on one end side, and the negative electrode layers 2 are each connected to a terminal electrode 6 disposed on the other end side.

The positive electrode layer 1 is an example of a first electrode layer, and the negative electrode layer 2 is an example of a second electrode layer. Any one of the first electrode layer and the second electrode layer functions as a positive electrode, and the other functions as a negative electrode. Whether an electrode layer is positive or negative depends on what polarity is connected to the terminal electrode 5 or 6.

The positive electrode layer 1 has a positive electrode current collector layer 1A and a positive electrode active material layer 1B formed on one surface or both surfaces of the positive electrode current collector layer 1A. On the surface of the positive electrode current collector layer 1A on which there is no facing negative electrode 2, the positive electrode active material layer 1B may not be provided. The negative electrode layer 2 has a negative electrode current collector layer 2A and a negative electrode active material layer 2B formed on one surface or both surfaces of the negative electrode current collector layer 2A. On the surface of the negative electrode current collector layer 2A on which there is no facing positive electrode 1, the negative electrode active material layer 2B may not be provided. For example, the positive electrode layer 1 or the negative electrode layer 2 that is positioned as the uppermost layer or the lowermost layer of the laminate 4 may not have the positive electrode active material layer 1B or the negative electrode active material layer 2B on a single surface.

The all-solid-state battery 10 according to the present embodiment is an all-solid-state battery having the solid electrolyte layer 3 between a pair of the electrode layers, and the positive electrode active material layer 1B and the negative electrode active material layer 2B contain carbon particles having an average interplanar spacing d002 of smaller than 0.342 (nm).

The carbon particles having an average interplanar spacing d002 of smaller than 0.342 (nm) have favorable crystallinity as a graphite structure and cause periodic disarray to a small extent and thereby have a high electron conductivity. When an electrode is formed by mixing these carbon particles and an active material, the thermal stability is high, and it becomes possible to easily leave the carbon particles in the electrode even in the case of using a process involving after a heat treatment such as sintering. Therefore, a small amount of the carbon particles added make it possible to obtain a high electron conductivity, and thus a high-density electrode can be realized. Furthermore, these carbon particles have high crystallinity and thus have a high electron conductivity. Therefore, when an electrode is formed by mixing these carbon particles and an active material, it was possible to increase the electron conductivity of the electrode by adding a small amount of the carbon particles and to decrease the internal resistance of an all-solid-state battery.

In addition, a small number of pores may be generated in the vicinity of each of the carbon particles due to the evaporation of carbon during the heat treatment or the like.

The interplanar spacings d002 of the carbon particles of the present embodiment can be calculated using, for example, an X-ray diffractometer (device name: Xpert-N, manufactured by Malvem Panalytical Ltd.) from the peak angle of a plane index (002) and 2d·sin θ=n·λ (here, d is the interplanar spacing, θ is a measurement angle, n is an arbitrary integer, and λ is the wavelength of an X-ray used).

Furthermore, the positive electrode active material layer 1B and the negative electrode active material layer 2B of the all-solid-state battery 10 according to the present embodiment preferably contain the carbon particles for which, in a case where the major axis of the particle is indicated by a and the minor axis is indicated by b, the ratio thereof is 1.0<a/b.

According to such a configuration, the use of the carbon particles having small shape anisotropy makes it possible to densely fill an active material with the carbon particles together with active material particles and increases the contact area with the active material, which enables smooth electron transfer. Therefore, the electron conductivity in the electrodes becomes high, and it is possible to decrease the internal resistance of the all-solid-state battery 10.

Furthermore, the positive electrode active material layer 1B and the negative electrode active material layer 2B of the all-solid-state battery 10 according to the present embodiment preferably contain the carbon particles for which, in the particle size distribution, D10 is 0.1 μm or more and D90 is 5.0 μm or less. D10 is the diameter of a particle at a cumulative volume of 10 vol % in a distribution curve obtained by the particle size distribution measurement of equivalent circle diameters calculated based on the area data of the carbon particles. In addition, D90 is the diameter of a particle at a cumulative value of 90% in the distribution curve obtained by the particle size distribution measurement.

According to such a configuration, it is possible to appropriately bring the carbon particles into contact with the active material, and, furthermore, the carbon particles can be brought into contact with the active material without generating pores between the active material and the carbon particle, and thus it becomes possible to smoothly exchange electrons, and the internal resistance of the all-solid-state battery can be decreased. In addition, in a case where fine particles having D10 of less than 0.1 μm are not included, the carbon particles being evaporated during a process such as a heat treatment are suppressed, and a sufficient effect is guaranteed.

The positive electrode active material layer 1B and the negative electrode active material layer 2B of the all-solid-state battery 10 according to the present embodiment each preferably contain 0.5 (wt %) or more and 15.0 (wt %) or less of the carbon particles.

According to the content of the carbon atoms with such a configuration, the carbon particles sufficiently come into contact with each other, the electron conductivity as the electrode can be increased, and it becomes possible to suppress a substantial decrease in the amount of the active material, and thus a high capacity can be obtained while the internal resistance of the all-solid-state battery 10 is decreased.

### (Carbon Particles)

When the carbon particles of the present embodiment are carbon particles having an average interplanar spacing d002 of smaller than 0.342 (nm), the carbon particles may be an artificial composition or a natural mineral.

### (Solid Electrolyte)

The solid electrolyte layer 3 is at least partially sandwiched by the positive electrode layer 1 and the negative electrode layer 2. As shown in FIG. 1, at least a part of the solid electrolyte layer 3 may be position in the in-plane direction of the positive electrode layer 1 and the negative electrode layer 2. As a solid electrolyte in the solid electrolyte layer 3, for example, a material having an ion conductive property and an electron conductive property that is small enough to be ignored is used. Examples of the solid electrolyte include lithium halide, lithium nitride, lithium oxyate and derivatives thereof. In addition, examples thereof include Li—P—O-based compounds such as lithium phosphate (Li₃PO₄), LIPON (LiPO₄₋ₓNₓ) obtained by mixing nitrogen with lithium phosphate, Li—Si—O-based compounds such as Li₄SiO₄, Li—P—Si—O-based compounds, Li—VSi—P-based compounds, perovskite-based compounds having a perovskite structure such as La_{0.51}Li0.35TiO_{2.94}, La_{0.55}Li_{0.35}TiO₃ and Li₃ₓLa_{2/3-x}TiO₃ and compounds having a garnet structure having Li, La and Zr, and, in particular, a compound having a NASICON structure is preferably contained. The composition of the compound having a NASICON structure is represented by LiₓM_{y}(PO₄)₃ (x=1 to 2, y=1 to 2 and M=at least one of Ti, Ge, Al, Ga and Zr is contained), and some of P may be substituted by B, Si or the like. Examples of the compound having a NASICON structure include Li_{1.3}Al_{0.3}Ti_{1.7}(PO₄)₃ and Li_{1.5}Al_{0.5}Ge_{1.5}(PO₄)₃.

### (Negative Electrode Active Material)

The negative electrode active material layer 2B has a negative electrode active material. As the negative electrode active material, Li₄Ti₅O₁₂, an oxide of at least one element selected from the group consisting of Ti, Nb, W, Si, Sn, Cr, Fe and Mo, a phosphorus-containing compound such as Li₃V₂(PO₄)₃ or LiFePO₄ or the like may be used.

### (Positive Electrode Active Material)

The positive electrode active material layer 1B has a positive electrode active material. As the positive electrode active material, a lamellar compound such as LiCoO₂ or LiCo_{1/3}Ni_{1/3}Mn_{1/3}O₂, a spinel material such as LiMn₂O₄ or LiNi_{0.5}Mn_{1.5}O₄, a phosphorus-containing compound such as Li₃V₂(PO₄)₃ or LiFePO₄ or the like may be used. As long as a carbon material of the present invention is contained in at least one of the positive electrode active material and the negative electrode active material, the effect of the present invention is exhibited.

There is no clear discrimination between substances that configure the positive electrode active material layer 1B and the negative electrode active material layer 2B, and it is possible to compare the potentials of two kinds of compounds, that is, a compound in the positive electrode active material layer 1B and a compound in the negative electrode active material layer 2B, use a compound exhibiting a higher potential as the positive electrode active material and use a compound exhibiting a lower potential as the negative electrode active material. In addition, the same material may be used as the active materials that configure the positive electrode active material layer 1B and the negative electrode active material layer 2B as long as the compound has both a lithium ion emission function and a lithium ion absorption function. When the same material is used as the active materials that configure the positive electrode active material layer 1B and the negative electrode active material layer 2B, since the all-solid-state battery becomes nonpolar, there is no need to designate directions even at the time of mounting the electrode active material layers on a circuit board, and thus mountability can be facilitated.

### (Current Collector)

As materials that configure the positive electrode current collector layer 1A and the negative electrode current collector layer 2A, a material having a high electrical conductivity is preferably used, and, for example, silver, palladium, gold, platinum, aluminum, copper, nickel, or the like is preferably used. Particularly, copper is preferable since copper does not easily react with lithium aluminum titanium phosphate and is, furthermore, effective for the reduction of the internal resistance of the all-solid-state battery. The materials that configure the electrode current collector layers may be the same as or different from each other in the positive electrode layer and the negative electrode layer.

In addition, the positive electrode current collector layer 1A and the negative electrode current collector layer 2A of the all-solid-state battery in the present embodiment preferably contain a positive electrode active material and a negative electrode active material, respectively.

When positive electrode current collector layer 1A and the negative electrode current collector layer 2A contain the positive electrode active material layer 1B and the negative electrode active material 2B, respectively, the adhesiveness between the positive electrode current collector layer 1A and the positive electrode active material layer 1B and the adhesiveness between the negative electrode current collector layer 2A and the negative electrode active material layer 2B improve, which is desirable.

### (Terminal Electrodes)

The terminal electrodes 5 and 6 are formed in contact with the side surfaces of a sintered body. The terminal electrodes 5 and 6 are connected to external terminals to play a role of sending and receiving electrons to and from the sintered body.

For the terminal electrodes 5 and 6, a material having a high electrical conductivity is preferably used. For example, silver, gold, platinum, aluminum, copper, tin, nickel, gallium, indium, alloys thereof and the like can be used.

(Method for Manufacturing of all-Solid-State Battery)

In a method for manufacturing the all-solid-state battery of the present embodiment, first, individual materials for the positive electrode current collector layer, the positive electrode active material layer, the solid electrolyte layer, the negative electrode active material layer and the negative electrode current collector layer are made into pastes, and the pastes are applied and dried to produce green sheets (first step). Next, such green sheets are laminated to produce a laminate (second step). Next, the produced laminate is fired at the same time, thereby manufacturing the all-solid-state battery (third step).

### (First Step)

First, a positive electrode active material, a negative electrode active material and a carbon material are prepared. At this time, in a case where the active material contains compounds of two or more kinds of elements, a mixed material may be prepared by mixing the compounds of the individual elements. In addition, in a case where a solid electrolyte is mixed with the active material as well, a mixed material may be prepared.

A method for producing the paste for the positive electrode active material layer and the paste for the negative electrode active material layer is not particularly limited, and the paste can be obtained by mixing the positive electrode active material or the negative electrode active material and the carbon material with a vehicle. Here, the vehicle is a collective term for media in a liquid phase. The vehicle contains a solvent and a binder. By such a method, the paste for the positive electrode current collector layer, the paste for the positive electrode active material layer, the paste for the solid electrolyte layer, the paste for the negative electrode active material layer and the paste for the negative electrode current collector layer are produced.

The produced pastes are applied onto a base material of PET or the like in desired order and dried as necessary, and the base material is peeled off, thereby producing green sheets. A method for applying the paste is not particularly limited, and it is possible to adopt a well-known method such as screen printing, application, transfer or a doctor blade.

### (Second Step)

The produced green sheets are stacked as many as desired in desired order, and alignment, cutting or the like is carried out as necessary, thereby producing a laminate. In the case of producing a parallel type or serial-parallel type battery, the green sheets are preferably aligned such that the end faces of the positive electrode layers and the end faces of the negative electrode layers do not coincide with each other and stacked.

At the time of producing the laminate, the laminate may be produced by preparing active material layer units to be described below.

In the method, first, a sheet of the paste for the solid electrolyte layer is formed on a PET film by the doctor blade method to obtain a solid electrolyte sheet, and then the paste for the positive electrode active material layer is printed by screen printing and dried on the solid electrolyte sheet. Next, the paste for the positive-electrode current collector layer is printed by screen printing and dried thereon. Furthermore, the paste for the positive electrode active material layer is printed again by screen printing and dried thereon, and then the PET film is peeled off, thereby obtaining a positive electrode active material layer unit. The positive electrode active material layer unit in which the paste for the positive electrode active material, the paste for the positive electrode current collector layer, and the paste for the positive electrode active material are formed in this order on the sheet for the solid electrolyte layer is obtained as described above. A negative electrode active material layer unit is also produced in the same order, and the negative electrode active material layer unit in which the paste for the negative electrode active material, the paste for the negative electrode current collector layer, and the paste for the negative electrode active material are formed in this order on the solid electrolyte layer sheet is obtained.

One positive electrode active material layer unit and one negative electrode active material layer are stacked so as to have the solid electrolyte sheet interposed therebetween. At this time, the individual units are unevenly stacked such that the paste for the positive electrode current collector layer in the first positive electrode active material layer unit extends up to only one end face and the paste for the negative electrode current collector layer of the second negative electrode active material layer unit extends up to only the other end face. Solid electrolyte sheets having a predetermined thickness are further stacked on both surfaces of these stacked units, thereby producing a laminate.

The produced laminate is collectively bonded by pressure. The laminate is bonded by pressure under heating, and the heating temperature is set to, for example, 40° C. to 95° C.

### (Third Step)

The pressure-bonded laminate is heated, for example, to 600° C. to 1100° C. in a nitrogen atmosphere and fired. The firing time is set to, for example, 0.1 to 3 hours. The laminate is completed by this firing.

Furthermore, in order to efficiently extract a current from the sintered body, external electrodes can be provided. The external electrodes are each connected to the positive electrode layers extending up to one side surface of the sintered body at one end and the negative electrode layers extending up to one side surface of the sintered body at one end. Therefore, a pair of terminal electrodes is formed so as to sandwich either side surface of the sintered body. Examples of a method for forming the external electrode include a sputtering method, a screen printing method, a dip coating method, and the like. In the screen printing method and the dip coating method, a paste for the external electrode containing metal powder, a resin and a solvent is produced, and this paste is used to form the external electrode. Next, a baking step for removing the solvent and a plating treatment for protecting and mounting the surface of the external electrode are carried out. Incidentally, in the sputtering method, since it is possible to form a protective layer or a layer for mounting on the external electrode, the baking step and the plating treatment step become unnecessary.

The all-solid-state battery can be manufactured by carrying out the steps as described above.

The present invention is not always limited only to the above-described embodiment, and a variety of modifications can be added within the scope of the gist of the present invention. That is, the individual configurations in the embodiment, a combination thereof, and the like are simply examples, and the addition, omission, substitution, and other modifications of the configuration can be added within the scope of the gist of the present invention.

### EXAMPLES

### Examples 1 to 4

The contents of the present invention will be more specifically described with reference to examples and comparative examples, but the present invention is not limited to the following examples.

### (Production of Positive Electrode Active Material)

In order to verify the effect of the present embodiment, Li₃V₂(PO₄)₃ was used as an active material. As starting materials, LiPO₃ and V₂O₃ were used, the starting materials were weighed and then mixed and pulverized in ethanol with a ball mill (120 rpm/zirconia balls) for 16 hours. The mixed powder of the starting materials was separated from the balls and ethanol, dried and then calcined using a magnesia crucible. The mixed powder was calcined at 950° C. for 2 hours in a reducing atmosphere, and then the calcined powder was treated for pulverization in ethanol with the ball mill (120 rpm/zirconia balls) for 16 hours. The pulverized powder was separated from the balls and ethanol and dried, and then a Li₃V₂(PO₄)₃ powder was obtained.

### (Production of Negative Electrode Active Material)

As a negative electrode active material, the same powder as the positive electrode active material was used.

### (Production of Solid Electrolyte)

As a solid electrolyte, Li_{1.3}Al_{0.3}Ti_{1.7}(PO₄)₃ produced by the following method was used. Li₂CO₃, Al₂O₃, TiO₂ and NH₄H₂PO₄ were used as starting materials and mixed in a wet manner in ethanol as a solvent with the ball mill for 16 hours. The mixed powder of the starting materials was separated from the balls and ethanol, dried and then calcined in an alumina crucible at 850° C. for 2 hours in the atmosphere. After that, the calcined powder was treated for pulverization in ethanol with the ball mill (120 rpm/zirconia balls) for 16 hours. The pulverized powder was separated from the balls and ethanol and dried, thereby obtaining a powder.

### (Mixing of Active Material and Carbon Material)

In order to verify the effect of the present embodiment, as Examples 1 to 4, carbon materials for which D10 was 0.25 μm, D90 was 4.5 μm, a/b was 3, the average interplanar spacings d002 were each 0.3354, 0.3365, 0.3380 or 0.3410 (nm) were used. In addition, as an active material, the above-described Li₃V₂(PO₄)₃ was used. First, the carbon materials having the corresponding average interplanar spacing were each weighed to be 10.7, 11.3, 12.6 or 13.5 (wt %) with respect to Li₃V₂(PO₄)₃ and mixed in an organic solvent using the ball mill. The powder was separated from the balls and the organic solvent and dried, thereby obtaining a mixed powder of the carbon material and Li₃V₂(PO₄)₃. Here, the carbon materials added to Li₃V₂(PO₄)₃ are recorded in a table as the prepared and added amount.

### (Production of Paste for Positive Electrode Active Material Layer and Paste for Negative Electrode Active Material Layer)

As pastes for positive electrode and negative electrode active material layers, ethyl cellulose (15 parts) as a binder and dihydroterpineol (65 parts) as a solvent were added to the mixed powder of the carbon material and Li₃V₂(PO₄)₃ (100 parts), mixed and dispersed with a triple roll mill, thereby producing pastes for active material layers that were to become a positive electrode and a negative electrode.

### (Production of Paste for Solid Electrolyte Layer)

As a solid electrolyte, the above-described Li_{1.3}Al_{0.3}Ti_{1.7}(PO₄)₃ powder was used. Ethanol (100 parts) and toluene (200 parts) were added as solvents to this powder (100 parts) and mixed in a wet manner with the ball mill. After that, a polyvinyl butyral-based binder (16 parts) and benzyl butyl phthalate (4.8 parts) were further injected thereinto and mixed, thereby preparing a paste for a solid electrolyte layer.

### (Production of Sheet for Solid Electrolyte Layer)

This paste for a solid electrolyte layer was formed into a sheet on a PET film as a base material by the doctor blade method, and a 15 μm-thick sheet for a solid electrolyte layer was obtained.

### (Production of Paste for Positive Electrode Current Collector Layer and Negative Electrode Current Collector Layer Paste)

A Cu powder and a Li₃V₂(PO₄)₃ powder were mixed together such that the volume ratio reached 100:9, and ethyl cellulose (10 parts) as a binder and dihydroterpineol (50 parts) as a solvent were added thereto, mixed and dispersed with the triple roll mill, thereby producing a paste for a positive electrode current collector layer and a paste for a negative electrode current collector layer.

### (Production of Terminal Electrode Paste)

A silver powder, an epoxy resin and a solvent were mixed and dispersed, thereby producing a thermoset-type terminal electrode paste.

### (Production of Active Material Layer Unit)

The pate for the electrode current collector layer was printed in a thickness of 5 μm by screen printing on the sheet for the solid electrolyte layer and dried at 80° C. for 10 minutes. The paste for the positive electrode active material layer was printed thereon in a thickness of 5 μm by screen printing and dried at 80° C. for 10 minutes, thereby producing a positive electrode layer unit. On the other hand, the paste for the negative electrode active material layer was printed in a thickness of 5 μm by screen printing on the sheet for the solid electrolyte layer and dried at 80° C. for 10 minutes, and then the pate for the electrode current collector layer was printed thereon in a thickness of 5 μm by screen printing and dried at 80° C. for 10 minutes, thereby producing a negative electrode layer unit. Next, the PET film was peeled off.

### (Production of Laminate)

The positive electrode layer unit, the negative electrode layer unit and the sheet for the solid electrolyte layer were used and stacked such that the solid electrolyte layer, the positive electrode current collector layer, the positive electrode active material layer, the solid electrolyte layer, the negative electrode active material layer, the negative electrode current collector layer and the solid electrolyte layer were formed in this order, thereby obtaining a laminate. At this time, the individual units were unevenly stacked such that the positive electrode current collector layer in the positive electrode layer unit extended up to only one end face and the negative electrode current collector layer of the negative electrode active material layer unit extended up to only the other end face. After that, these units were formed by thermo-compression bonding and then cut, thereby producing a laminate.

### (Production of Sintered Body)

On the obtained laminate, debinding was carried out, and then simultaneous firing was carried out, thereby obtaining a sintered body. During the debinding, the laminate was heated at 50° C./hour up to a firing temperature of 700° C. in nitrogen and held at the temperature for 10 hours, and, during the simultaneous firing, the laminate was heated at a temperature rise rate of 200° C./hour up to a firing temperature of 850° C. in nitrogen, held at the temperature for one hour, and naturally cooled after the firing.

In addition, it was confirmed that the residual content of carbon in the electrode active material layer region in the obtained sintered body was almost 10 (wt %).

### (Production of Terminal Electrode)

The terminal electrode paste was applied to end faces of the sintered body and thermally cured at 150° C. for 30 minutes, thereby forming a pair of terminal electrodes. An all-solid-state battery was completed as described above.

(Evaluation of Average Interplanar Spacing d002 of Carbon Particles in Electrode Active Material Layers)

The electrode active material layer regions in the obtained sintered body are exposed by polishing or the like and processed to be flat, and the interplanar spacings d002 of the carbon particles can be calculated using, for example, an X-ray diffractometer (device name: Xpert-N, manufactured by Malvem Panalytical Ltd.) from the peak angle of a plane index (002) and 2d·sin θ=n·λ (here, d is the interplanar spacing, θ is the measurement angle, n is an arbitrary integer, and λ is the wavelength of an X-ray used).

### (Evaluation of Major Axis a and Minor Axis b of Carbon Particle in Electrode Active Material)

The electrode active material layer regions in the obtained sintered body are exposed by polishing or the like and processed to be flat, and, for 100 or more carbon particles in a visual field from scanning electron microscopic (SEM) observation, the length in the longest axis direction of each carbon particle is indicated by a, the length in the shortest axis direction is indicated by b, and the ratio can be calculated as a/b. As the magnification of the SEM, an appropriate value is selected depending on the particle diameters of the carbon particles, and a magnification is selected so that 100 or more and 300 or less particles can be observed in a visual field, a/b's of all carbon particles in the visual field are obtained, and the average thereof is calculated.

### (Evaluation of Particle Size Distribution of Carbon Particles in Electrode Active Material)

The electrode active material layer regions in the obtained sintered body are exposed by polishing or the like and processed to be flat, and, for 200 or more carbon particles in a visual field from scanning electron microscopic (SEM) observation, the area of each particle is measured using image processing. Equivalent circle diameters were calculated from these area data, the particle diameter at a cumulative volume of 10 vol % was indicated by D10, and the particle diameter at a cumulative volume of 90 vol % was indicated by D90.

### (Evaluation of Carbon Content in Electrode Active Material)

The electrode active material layer regions in the obtained sintered body were separated and pulverized, and the carbon content was measured with a carbon/sulfur analyzer (manufactured by LECO Japan Corporation, device name: CS-844) as an analyzer using the infrared absorption method after combustion.

### (Measurement of Relative Density)

The appearance dimensions of the obtained sintered body were measured, the volume was calculated, and the weight of the sintered body was divided by the volume, thereby obtaining the sintered body density. Incidentally, as the theoretical density of the shape dimensions, the theoretical density was obtained using the shape, dimensions and specific gravity of each configuration portion of the sintered body. Specifically, in order to obtain the theoretical density, first, the dimensions of each configuration portion of the sintered body were calculated. Here, each configuration portion of the sintered body refers to the portion of the solid electrolyte layer, the portion of the positive electrode active material layer, the portion of the positive electrode current collector layer, the portion of the negative electrode active material layer or the portion of the negative electrode current collector portion. Next, the volume of each configuration portion was calculated from the shape and dimensions of each configuration portion of the solid electrolyte layer. Next, the specific gravity and the calculated volume of each configuration portion of the solid electrolyte layer were multiplied by each other. As the specific gravity of each configuration portion, a well-known specific gravity was used. Next, these were summed, thereby calculating the weight of the sintered body. In the positive electrode active material and the negative electrode active material each having the active material and carbon, the weights were calculated in consideration of the presence ratio. Next, the calculated weight of the sintered body was divided by the volume of the sintered body, thereby calculating the theoretical density. After that, the ratio between the obtained sintered body density and the theoretical density was obtained and regarded as the relative density. The relative density can be obtained from (sintered body density/theoretical density).

### (Evaluation of Impedance)

The obtained laminate was installed in a jig to which the laminate was fixed with a spring-loaded pin, and the internal resistance was measured using an Impedance/Gain-Phase analyzer (manufactured by Solartron Analytical, device name: 1260A). The measurement frequency was 0.005 Hz, and the AC applied voltage was 0.05 V in the measurement. The values of the obtained internal resistance are shown in Table 1. A case where the value of the internal resistance was smaller than 1×10⁷ (Ω) was evaluated as favorable.

### (Evaluation of Charge and Discharge Characteristics)

Furthermore, the obtained laminate was installed in the jig to which the laminate was fixed with a spring-loaded pin, and the charge and discharge capacity was measured using a charge and discharge tester. As the measurement conditions, the currents at the time of charging and discharging were all 2 μA, and the voltage was 0 V to 1.6 V in the measurement. The measured discharge capacities are shown in Table 1. A case where the value of the discharge characteristic was larger than 1.5 μAh was evaluated as favorable.

### Comparative Example 1

In the present comparative example, a carbon material for which D10 was 0.25 μm, D90 was 4.5 μm, a/b was 3, the average interplanar spacing d002 was 0.3425 (nm) was used. In addition, as active materials, the above-described Li₃V₂(PO₄)₃ powder was used.

This carbon material was weighed to be 10 (wt %) with respect to Li₃V₂(PO₄)₃ and mixed in an organic solvent using a ball mill. The powder was separated from the balls and the organic solvent and dried, thereby obtaining a mixed powder of the carbon material and Li₃V₂(PO₄)₃. Furthermore, a laminate was produced using the same method as in Example 1, and then debinding and sintering were carried out by the same methods. The discharge characteristic of the laminate was evaluated by the same method as in Example 1. The value of the measured internal resistance and the discharge capacity are shown in Table 1.

As is clear from Table 1, it is found that, when the carbon material and the active material that are within the scope according to the present invention are used for active material layers, it is possible to leave an effective amount of the carbon material even in a case where a small amount of the carbon material is added, a dense electrode portion can be realized, and a clearly low internal resistance as an all-solid-state battery is exhibited. In addition, it is also found that a high discharge capacity can be obtained.

TABLE 1

| | Average | | | | | | | | |
|---|---|---|---|---|---|---|---|---|---|
| | interplanar | | | | Prepared and | Residual | | Discharge | Relative |
| | spacing d002 | D10 | D90 | | added amount | content | Imp (Ω) at | capacity | density |
| | (nm) | (μm) | (μm) | a/b ratio | (wt %) | (wt %) | 0.005 Hz | (μAh) | (%) |
| Example 1 | 0.3354 | 0.25 | 4.5 | 3.0 | 10.7 | 10 | 5.25 × 10⁵ | 6.05 | 97.88 |
| Example 2 | 0.3365 | 0.25 | 4.5 | 3.0 | 11.3 | 10 | 5.15 × 10⁵ | 8.15 | 96.65 |
| Example 3 | 0.3380 | 0.25 | 4.5 | 3.0 | 12.6 | 10 | 2.99 × 10⁶ | 4.53 | 93.45 |
| Example 4 | 0.3410 | 0.25 | 4.5 | 3.0 | 13.5 | 10 | 3.91 × 10⁶ | 3.85 | 87.59 |
| Comparative | 0.3425 | 0.25 | 4.5 | 3.0 | 16.3 | 10 | 1.03 × 10⁷ | 1.18 | 85.10 |
| Example 1 | | | | | | | | | |

### Examples 5 to 12

### (Mixing of Active Material and Carbon Material)

In order to verify the effect of the present embodiment, as Examples 5 to 12, carbon materials for which D10 was 0.25 μm, D90 was 4.5 μm, the average interplanar spacings d002 were each 0.33650.3380 (nm) and a/b's were each 1.0, 1.1, 1.5, 5.0, 10.0, 50.0, 100.0 or 200.0 were used. In addition, as active materials, the above-described Li₃V₂(PO₄)₃ powder was used. These carbon materials were each weighed to be 11.3 wt % with respect to Li₃V₂(PO₄)₃ and mixed in an organic solvent using the ball mill. The powder was separated from the balls and the organic solvent and dried, thereby obtaining a mixed powder of the carbon material and Li₃V₂(PO₄)₃.

### (Production of Paste for Positive Electrode Active Material Layer and Paste for Negative Electrode Active Material Layer)

As pastes for positive electrode and negative electrode active material layers, ethyl cellulose (15 parts) as a binder and dihydroterpineol (65 parts) as a solvent were added to the mixed powder of the carbon material and Li₃V₂(PO₄)₃ (100 parts), mixed and dispersed with a triple roll mill, thereby producing pastes for active material layers that were to become a positive electrode and a negative electrode.

### (Production of Paste for Solid Electrolyte Layer)

As a solid electrolyte, the above-described Li_{1.3}Al_{0.3}Ti_{1.7}(PO₄)₃ powder was used. Ethanol (100 parts) and toluene (200 parts) were added as solvents to this powder (100 parts) and mixed in a wet manner with the ball mill. After that, a polyvinyl butyral-based binder (16 parts) and benzyl butyl phthalate (4.8 parts) were further injected thereinto and mixed, thereby preparing a paste for a solid electrolyte layer.

### (Production of Sheet for Solid Electrolyte Layer)

This paste for a solid electrolyte layer was formed into a sheet on a PET film as a base material by the doctor blade method, and a 15 μm-thick sheet for a solid electrolyte layer was obtained.

### (Production of Paste for Positive Electrode Current Collector Layer and Paste for Negative Electrode Current Collector Layer)

A Cu powder and a Li₃V₂(PO₄)₃ powder were mixed together such that the volume ratio reached 100:9, and ethyl cellulose (10 parts) as a binder and dihydroterpineol (50 parts) as a solvent were added thereto, mixed and dispersed with the triple roll mill, thereby producing a paste for a positive electrode current collector layer and a paste for a negative electrode current collector layer.

### (Production of Terminal Electrode Paste)

A silver powder, an epoxy resin and a solvent were mixed and dispersed, thereby producing a thermoset-type terminal electrode paste.

### (Production of Active Material Layer Unit)

The pate for the positive electrode current collector layer was printed in a thickness of 5 μm by screen printing on the sheet for the solid electrolyte layer and dried at 80° C. for 10 minutes. The paste for the positive electrode active material layer was printed thereon in a thickness of 5 μm by screen printing and dried at 80° C. for 10 minutes, thereby producing a positive electrode layer unit. On the other hand, the paste for the negative electrode active material layer was printed in a thickness of 5 μm by screen printing on the sheet for the solid electrolyte layer and dried at 80° C. for 10 minutes, and then the pate for the negative electrode current collector layer was printed thereon in a thickness of 5 μm by screen printing and dried at 80° C. for 10 minutes, thereby producing a negative electrode layer unit. Next, the PET film was peeled off.

### (Production of Laminate)

The positive electrode layer unit, the negative electrode layer unit and the sheet for the solid electrolyte layer were used and stacked such that the solid electrolyte layer, the positive electrode current collector layer, the positive electrode active material layer, the solid electrolyte layer, the negative electrode active material layer, the negative electrode current collector layer and the solid electrolyte layer were formed in this order, thereby obtaining a one-layer product. At this time, the individual units were unevenly stacked such that the positive electrode current collector layer in the positive electrode layer unit extended up to only one end face and the negative electrode current collector layer of the negative electrode layer unit extended up to only the other end face. After that, these units were formed by thermo-compression bonding and then cut, thereby producing a laminate.

### (Production of Sintered Body)

On the obtained laminate, debinding was carried out, and then simultaneous firing was carried out, thereby obtaining a sintered body. During the debinding, the laminate was heated at 50° C./hour up to a firing temperature of 700° C. in nitrogen and held at the temperature for 10 hours, and, during the simultaneous firing, the laminate was heated at a temperature rise rate of 200° C./hour up to a firing temperature of 850° C. in nitrogen, held at the temperature for one hour, and naturally cooled after the firing.

In addition, it was confirmed that the residual content of carbon in the electrode active material layer region in the obtained sintered body was almost 10 (wt %).

### (Production of Terminal Electrode)

The terminal electrode paste was applied to end faces of the sintered body and thermally cured at 150° C. for 30 minutes, thereby forming a pair of terminal electrodes. An all-solid-state battery was completed as described above.

(Evaluation of Average Interplanar Spacing d002 of Carbon Particles in Electrode Active Material Layers)

The electrode active material layer regions in the obtained sintered body were exposed by polishing or the like and processed to be flat, and the interplanar spacings d002 of the carbon particles were calculated using an X-ray diffractometer (device name: Xpert-N, manufactured by Malvem Panalytical Ltd.) from the peak angle of a plane index (002) and 2d·sin θ=n·λ (here, d is the interplanar spacing, θ is a measurement angle, n is an arbitrary integer, and λ is the wavelength of an X-ray used).

### (Evaluation of Major Axis a and Minor Axis b of Carbon Particle in Electrode Active Material)

The electrode active material layer regions in the obtained sintered body are exposed by polishing or the like and processed to be flat, and, for 100 or more particles in a visual field from scanning electron microscopic (SEM) observation, the length in the longest axis direction is indicated by a, the length in the shortest axis direction is indicated by b, and the ratio can be calculated as a/b. As the magnification of the SEM, an appropriate value is selected depending on the particle diameters of the carbon particles, and a magnification is selected so that 100 or more and 300 or less particles can be observed in a visual field. The a/b ratio of the carbon particle was calculated as the average of a/b's of all of the carbon particles in the visual field.

### (Evaluation of Particle Size Distribution of Carbon Particles in Electrode Active Material)

The electrode active material layer regions in the obtained sintered body are exposed by polishing or the like and processed to be flat, and, for 200 or more carbon particles in a visual field from scanning electron microscopic (SEM) observation, the area of each particle is measured using image processing. Equivalent circle diameters were calculated from these area data, the particle diameter at a cumulative volume of 10 vol % was indicated by D10, and the particle diameter at a cumulative volume of 90 vol % was indicated by D90.

### (Evaluation of Carbon Content in Electrode Active Material)

The electrode active material layer regions in the obtained sintered body were separated and pulverized, and the carbon content was measured with a carbon/sulfur analyzer (manufactured by LECO Japan Corporation, device name: CS-844) as an analyzer using the infrared absorption method after combustion.

### (Measurement of Relative Density)

The appearance dimensions of the obtained sintered body were measured, the volume was calculated, and the weight of the sintered body was divided by the volume, thereby obtaining the sintered body density. Incidentally, the theoretical density of the shape dimensions was calculated, and then the ratio between the obtained sintered body density and the theoretical density was obtained and regarded as the relative density.

### (Evaluation of Impedance)

The obtained laminate was installed in a jig to which the laminate was fixed with a spring-loaded pin, and the internal resistance was measured using an Impedance/Gain-Phase analyzer. The measurement frequency was 0.005 Hz, and the AC applied voltage was 0.05 V in the measurement. The values of the obtained internal resistance are shown in Table 2. A case where the value of the internal resistance was smaller than 1×10⁷ (Ω) was evaluated as favorable.

### (Evaluation of Charge and Discharge Characteristics)

Furthermore, the obtained laminate was installed in the jig to which the laminate was fixed with a spring-loaded pin, and the charge and discharge capacity was measured using a charge and discharge tester. As the measurement conditions, the currents at the time of charging and discharging were all 2 μA, and the voltage was 0 V to 1.6 V in the measurement. The measured discharge capacities are shown in Table 2.

As is clear from Table 2, it is found that all-solid-state batteries in which the carbon material having a/b within the scope according to the present invention is used for each of the positive electrode active material layer and the negative electrode active material layer exhibit a clearly low internal resistance. In addition, it is found that, when the a/b value is within a range of 1.1 to 100.0, a favorable discharge capacity can be obtained while a lower internal resistance is exhibited. In addition, it is found that, when the a/b value is within a range of 1.5 to 5.0, a more favorable discharge capacity can be obtained while a lower internal resistance is exhibited.

TABLE 2

| | Average | | | | | | | | |
|---|---|---|---|---|---|---|---|---|---|
| | interplanar | | | | Prepared and | Residual | | Discharge | Relative |
| | spacing d002 | D10 | D90 | | added amount | content | Imp (Ω) at | capacity | density |
| | (nm) | (μm) | (μm) | a/b ratio | (wt %) | (wt %) | 0.005 Hz | (μAh) | (%) |
| Example 5 | 0.3365 | 0.25 | 4.5 | 1.0 | 11.3 | 10 | 9.53 × 10⁶ | 1.25 | 93.75 |
| Example 6 | 0.3365 | 0.25 | 4.5 | 1.1 | 11.3 | 10 | 4.86 × 10⁶ | 3.05 | 95.20 |
| Example 7 | 0.3365 | 0.25 | 4.5 | 1.5 | 11.3 | 10 | 2.00 × 10⁶ | 5.98 | 96.17 |
| Example 2 | 0.3365 | 0.25 | 4.5 | 3.0 | 11.3 | 10 | 5.15 × 10⁵ | 8.15 | 96.65 |
| Example 8 | 0.3365 | 0.25 | 4.5 | 5.0 | 11.3 | 10 | 1.99 × 10⁶ | 4.53 | 95.68 |
| Example 9 | 0.3365 | 0.25 | 4.5 | 10.0 | 11.3 | 10 | 3.81 × 10⁶ | 3.83 | 94.72 |
| Example 10 | 0.3365 | 0.25 | 4.5 | 50.0 | 11.3 | 10 | 6.00 × 10⁶ | 2.25 | 91.82 |
| Example 11 | 0.3365 | 0.25 | 4.5 | 100.0 | 11.3 | 10 | 6.90 × 10⁶ | 2.15 | 89.88 |
| Example 12 | 0.3365 | 0.25 | 4.5 | 200.0 | 11.3 | 10 | 9.21 × 10⁶ | 1.35 | 87.95 |

### Examples 13 to 15

### (Mixing of Active Material and Carbon Material)

In order to verify the effect of the present embodiment, as Examples 13 to 15, carbon materials for which the average interplanar spacing d002 was 0.3365 (nm), a/b was 3.0, D10 was 0.1 μm and D90 was 5 μm (Example 13), D10 was 0.2 μm and D90 was 5.5 μm (Example 14) and D10 was 0.08 μm and D90 was 4.0 μm (Example 15) were used. In addition, as active materials, the above-described Li₃V₂(PO₄)₃ powder was used. These carbon materials were each weighed to be 11.3 wt % with respect to Li₃V₂(PO₄)₃ and mixed in an organic solvent using the ball mill. The powder was separated from the balls and the organic solvent and dried, thereby obtaining a mixed powder of the carbon material and Li₃V₂(PO₄)₃.

### (Production of Paste for Positive Electrode Active Material Layer and Paste for Negative Electrode Active Material Layer)

As pastes for positive electrode and negative electrode active material layers, ethyl cellulose (15 parts) as a binder and dihydroterpineol (65 parts) as a solvent were added to the mixed powder of the carbon material and Li₃V₂(PO₄)₃ (100 parts), mixed and dispersed with a triple roll mill, thereby producing pastes for active material layers that were to become a positive electrode and a negative electrode.

### (Production of Paste for Solid Electrolyte Layer)

As a solid electrolyte, the above-described Li_{1.3}Al_{0.3}Ti_{1.7}(PO₄)₃ powder was used. Ethanol (100 parts) and toluene (200 parts) were added as solvents to this powder (100 parts) and mixed in a wet manner with the ball mill. After that, a polyvinyl butyral-based binder (16 parts) and benzyl butyl phthalate (4.8 parts) were further injected thereinto and mixed, thereby preparing a paste for a solid electrolyte layer.

### (Production of Sheet for Solid Electrolyte Layer)

This paste for a solid electrolyte layer was formed into a sheet on a PET film as a base material by the doctor blade method, and a 15 μm-thick sheet for a solid electrolyte layer was obtained.

### (Production of Paste for Positive Electrode Current Collector Layer and Paste for Negative Electrode Current Collector Layer)

A Cu powder and a Li₃V₂(PO₄)₃ powder were mixed together such that the volume ratio reached 100:9, and ethyl cellulose (10 parts) as a binder and dihydroterpineol (50 parts) as a solvent were added thereto, mixed and dispersed with the triple roll mill, thereby producing a paste for a positive electrode current collector layer and a paste for a negative electrode current collector layer.

### (Production of Terminal Electrode Paste)

A silver powder, an epoxy resin and a solvent were mixed and dispersed, thereby producing a thermoset-type terminal electrode paste.

### (Production of Active Material Layer Unit)

The pate for the positive electrode current collector layer was printed in a thickness of 5 μm by screen printing on the sheet for the solid electrolyte layer and dried at 80° C. for 10 minutes. The paste for the positive electrode active material layer was printed thereon in a thickness of 5 μm by screen printing and dried at 80° C. for 10 minutes, thereby producing a positive electrode layer unit. On the other hand, the paste for the negative electrode active material layer was printed in a thickness of 5 μm by screen printing on the sheet for the solid electrolyte layer and dried at 80° C. for 10 minutes, and then the pate for the negative electrode current collector layer was printed thereon in a thickness of 5 μm by screen printing and dried at 80° C. for 10 minutes, thereby producing a negative electrode layer unit. Next, the PET film was peeled off.

### (Production of Laminate)

The positive electrode layer unit, the negative electrode layer unit and the sheet for the solid electrolyte layer were used and stacked such that the solid electrolyte layer, the positive electrode current collector layer, the positive electrode active material layer, the solid electrolyte layer, the negative electrode active material layer, the negative electrode current collector layer and the solid electrolyte layer were formed in this order, thereby obtaining a one-layer product. At this time, the individual units were unevenly stacked such that the positive electrode current collector layer in the positive electrode layer unit extended up to only one end face and the negative electrode current collector layer of the negative electrode layer unit extended up to only the other end face. After that, these units were formed by thermo-compression bonding and then cut, thereby producing a laminate.

### (Production of Sintered Body)

On the obtained laminate, debinding was carried out, and then simultaneous firing was carried out, thereby obtaining a sintered body. During the debinding, the laminate was heated at 50° C./hour up to a firing temperature of 700° C. in nitrogen and held at the temperature for 10 hours, and, during the simultaneous firing, the laminate was heated at a temperature rise rate of 200° C./hour up to a firing temperature of 850° C. in nitrogen, held at the temperature for one hour, and naturally cooled after the firing.

In addition, it was confirmed that the residual content of carbon in the electrode active material layer region in the obtained sintered body was almost 10 (wt %).

### (Production of Terminal Electrode)

The terminal electrode paste was applied to end faces of the sintered body and thermally cured at 150° C. for 30 minutes, thereby forming a pair of terminal electrodes. An all-solid-state battery was completed as described above.

(Evaluation of Average Interplanar Spacing d002 of Carbon Particles in Electrode Active Material Layers)

The electrode active material layer regions in the obtained sintered body were exposed by polishing or the like and processed to be flat, and the interplanar spacings d002 of the carbon particles were calculated using an X-ray diffractometer (device name: Xpert-N, manufactured by Malvem Panalytical Ltd.) from the peak angle of a plane index (002) and 2d·sin θ=n·λ (here, d is the interplanar spacing, θ is a measurement angle, n is an arbitrary integer, and λ is the wavelength of an X-ray used).

### (Evaluation of Major Axis a and Minor Axis b of Carbon Particle in Electrode Active Material)

The electrode active material layer regions in the obtained sintered body are exposed by polishing or the like and processed to be flat, and, for 100 or more particles in a visual field from scanning electron microscopic (SEM) observation, the length in the longest axis direction is indicated by a, the length in the shortest axis direction is indicated by b, and the ratio can be calculated as a/b. As the magnification of the SEM, an appropriate value is selected depending on the particle diameters of the carbon particles, and a magnification is selected so that 100 or more and 300 or less particles can be observed in a visual field, a/b of the carbon particle was calculated as the average of a/b's of all of the carbon particles in the visual field.

### (Evaluation of Particle Size Distribution of Carbon Particles in Electrode Active Material)

The electrode active material layer regions in the obtained sintered body are exposed by polishing or the like and processed to be flat, and, for 200 or more carbon particles in a visual field from scanning electron microscopic (SEM) observation, the area of each particle is measured using image processing. Equivalent circle diameters were calculated from these area data, the particle diameter at a cumulative volume of 10 vol % was indicated by D10, and the particle diameter at a cumulative volume of 90 vol % was indicated by D90.

### (Evaluation of Carbon Content in Electrode Active Material)

The electrode active material layer regions in the obtained sintered body were separated and pulverized, and the carbon content was measured with a carbon/sulfur analyzer (manufactured by LECO Japan Corporation, device name: CS-844) as an analyzer using the infrared absorption method after combustion.

### (Measurement of Relative Density)

The appearance dimensions of the obtained sintered body were measured, the volume was calculated, and the weight of the sintered body was divided by the volume, thereby obtaining the sintered body density. Incidentally, the theoretical density of the shape dimensions was calculated, and then the ratio between the obtained sintered body density and the theoretical density was obtained and regarded as the relative density.

### (Evaluation of Impedance)

The obtained laminate was installed in a jig to which the laminate was fixed with a spring-loaded pin, and the internal resistance was measured using an Impedance/Gain-Phase analyzer. The measurement frequency was 0.005 Hz, and the AC applied voltage was 0.05 V in the measurement. The values of the obtained internal resistance are shown in Table 3. A case where the value of the internal resistance was smaller than 1×10⁷ (Ω) was evaluated as favorable.

### (Evaluation of Charge and Discharge Characteristics)

Furthermore, the obtained laminate was installed in the jig to which the laminate was fixed with a spring-loaded pin, and the charge and discharge capacity was measured using a charge and discharge tester. As the measurement conditions, the currents at the time of charging and discharging were all 2 μA, and the voltage was 0 V to 1.6 V in the measurement. The measured discharge capacities are shown in Table 3. A case where the value of the discharge characteristic was larger than 1.5 μAh was evaluated as favorable.

As is clear from Table 3, it is found that all-solid-state batteries in which the carbon material having D10 and D90 within the scope according to the present invention is used for each of the positive electrode active material layer and the negative electrode active material layer exhibit a clearly low internal resistance. In addition, it is found that, when D10 is 0.1 μm or more and D90 is 5.0 μm or less, a favorable discharge capacity can be obtained while a lower internal resistance is exhibited.

TABLE 3

| | Average | | | | | | | | |
|---|---|---|---|---|---|---|---|---|---|
| | interplanar | | | | Prepared and | Residual | | Discharge | Relative |
| | spacing d002 | D10 | D90 | | added amount | content | Imp (Ω) at | capacity | density |
| | (nm) | (μm) | (μm) | a/b ratio | (wt %) | (wt %) | 0.005 Hz | (μAh) | (%) |
| Example 13 | 0.3365 | 0.10 | 5.0 | 3.0 | 11.3 | 10 | 4.93 × 10⁶ | 3.07 | 92.30 |
| Example 2 | 0.3365 | 0.25 | 4.5 | 3.0 | 11.3 | 10 | 5.15 × 10⁵ | 8.15 | 96.65 |
| Example 14 | 0.3365 | 0.20 | 5.5 | 3.0 | 11.3 | 10 | 7.99 × 10⁶ | 1.45 | 94.23 |
| Example 15 | 0.3365 | 0.08 | 4.0 | 3.0 | 11.3 | 10 | 9.95 × 10⁶ | 1.18 | 92.30 |

### Examples 16 to 211

### (Mixing of Active Material and Carbon Material)

In order to verify the effect of the present embodiment, as Examples 16 to 21, carbon materials for which the average interplanar spacing d002 was 0.3380 (nm), a/b was 3, D10 was 0.25 μm and D90 was 4.5 μm were used. In addition, as active materials, the above-described Li₁V₂(PO₄)₃ powder was used. These carbon materials were each weighed to be 0.49 wt %, 0.58 wt %, 1.13 wt %, 7.12 wt %, 11.30 wt % or 16.95 wt % with respect to Li₃V₂(PO₄)₃ and mixed in an organic solvent using the ball mill. The powder was separated from the balls and the organic solvent and dried, thereby obtaining a mixed powder of the carbon material and Li₃V₂(PO₄)₃.

### (Production of Paste for Positive Electrode Active Material Layer and Paste for Negative Electrode Active Material Layer)

As pastes for positive electrode and negative electrode active material layers, ethyl cellulose (15 parts) as a binder and dihydroterpineol (65 parts) as a solvent were added to the mixed powder of the carbon material and Li₃V₂(PO₄)₃ (100 parts), mixed and dispersed with a triple roll mill, thereby producing pastes for active material layers that were to become a positive electrode and a negative electrode.

### (Production of Paste for Solid Electrolyte Layer)

As a solid electrolyte, the above-described Li_{1.3}Al_{0.3}Ti_{1.7}(PO₄)₃ powder was used. Ethanol (100 parts) and toluene (200 parts) were added as solvents to this powder (100 parts) and mixed in a wet manner with the ball mill. After that, a polyvinyl butyral-based binder (16 parts) and benzyl butyl phthalate (4.8 parts) were further injected thereinto and mixed, thereby preparing a paste for a solid electrolyte layer.

### (Production of Sheet for Solid Electrolyte Layer)

This paste for a solid electrolyte layer was formed into a sheet on a PET film as a base material by the doctor blade method, and a 15 μm-thick sheet for a solid electrolyte layer was obtained.

### (Production of Paste for Positive Electrode Current Collector Layer and Paste for Negative Electrode Current Collector Layer)

A Cu powder and a Li₃V₂(PO₄)₃ powder were mixed together such that the volume ratio reached 100:9, and ethyl cellulose (10 parts) as a binder and dihydroterpineol (50 parts) as a solvent were added thereto, mixed and dispersed with the triple roll mill, thereby producing a paste for a positive electrode current collector layer and a paste for a negative electrode current collector layer.

### (Production of Terminal Electrode Paste)

A silver powder, an epoxy resin and a solvent were mixed and dispersed, thereby producing a thermoset-type terminal electrode paste.

### (Production of Active Material Layer Unit)

The pate for the positive electrode current collector layer was printed in a thickness of 5 μm by screen printing on the sheet for the solid electrolyte layer and dried at 80° C. for 10 minutes. The paste for the positive electrode active material layer was printed thereon in a thickness of 5 μm by screen printing and dried at 80° C. for 10 minutes, thereby producing a positive electrode layer unit. On the other hand, the paste for the negative electrode active material layer was printed in a thickness of 5 μm by screen printing on the sheet for the solid electrolyte layer and dried at 80° C. for 10 minutes, and then the pate for the negative electrode current collector layer was printed thereon in a thickness of 5 μm by screen printing and dried at 80° C. for 10 minutes, thereby producing a negative electrode layer unit. Next, the PET film was peeled off.

### (Production of Laminate)

The positive electrode layer unit, the negative electrode layer unit and the sheet for the solid electrolyte layer were used and stacked such that the solid electrolyte layer, the positive electrode current collector layer, the positive electrode active material layer, the solid electrolyte layer, the negative electrode active material layer, the negative electrode current collector layer and the solid electrolyte layer were formed in this order, thereby obtaining a one-layer product. At this time, the individual units were unevenly stacked such that the positive electrode current collector layer in the positive electrode layer unit extended up to only one end face and the negative electrode current collector layer of the negative electrode layer unit extended up to only the other end face. After that, these units were formed by thermo-compression bonding and then cut, thereby producing a laminate.

### (Production of Sintered Body)

On the obtained laminate, debinding was carried out, and then simultaneous firing was carried out, thereby obtaining a sintered body. During the debinding, the laminate was heated at 50° C./hour up to a firing temperature of 700° C. in nitrogen and held at the temperature for 10 hours, and, during the simultaneous firing, the laminate was heated at a temperature rise rate of 200° C./hour up to a firing temperature of 850° C. in nitrogen, held at the temperature for one hour, and naturally cooled after the firing.

In addition, it was confirmed that the residual contents of carbon in the electrode active material layer regions in the obtained sintered bodies were 0.43, 0.51, 1.00, 6.30, 15.00 and 16.00 (wt %), respectively.

### (Production of Terminal Electrode)

The terminal electrode paste was applied to end faces of the sintered body and thermally cured at 150° C. for 30 minutes, thereby forming a pair of terminal electrodes. An all-solid-state battery was completed as described above.

(Evaluation of Average Interplanar Spacing d002 of Carbon Particles in Electrode Active Material Layers)

The electrode active material layer regions in the obtained sintered body were exposed by polishing or the like and processed to be flat, and the interplanar spacings d002 of the carbon particles were calculated using an X-ray diffractometer (device name: Xpert-N, manufactured by Malvem Panalytical Ltd.) from the peak angle of a plane index (002) and Bragg's equation 2d·sin θ=n·λ (here, d is the interplanar spacing, θ is a measurement angle, n is an arbitrary integer, and λ is the wavelength of an X-ray used).

### (Evaluation of Major Axis a and Minor Axis b of Carbon Particle in Electrode Active Material)

The electrode active material layer regions in the obtained sintered body are exposed by polishing or the like and processed to be flat, and, for 100 or more particles in a visual field from scanning electron microscopic (SEM) observation, the length in the longest axis direction is indicated by a, the length in the shortest axis direction is indicated by b, and the ratio can be calculated as a/b. As the magnification of the SEM, an appropriate value is selected depending on the particle diameters of the carbon particles, and a magnification is selected so that 100 or more and 300 or less particles can be observed in a visual field. The a/b ratio of the carbon particle was calculated as the average of a/b's of all of the carbon particles in the visual field.

### (Evaluation of Particle Size Distribution of Carbon Particles in Electrode Active Material)

The electrode active material layer regions in the obtained sintered body are exposed by polishing or the like and processed to be flat, and, for 200 or more carbon particles in a visual field from scanning electron microscopic (SEM) observation, the area of each particle is measured using image processing. Equivalent circle diameters were calculated from these area data, the particle diameter at a cumulative volume of 10 vol % was indicated by D10, and the particle diameter at a cumulative volume of 90 vol % was indicated by D90.

### (Evaluation of Carbon Content in Electrode Active Material)

The electrode active material layer regions in the obtained sintered body were separated and pulverized, and the carbon content was measured with a carbon/sulfur analyzer (manufactured by LECO Japan Corporation, device name: CS-844) as an analyzer using the infrared absorption method after combustion.

### (Measurement of Relative Density)

The appearance dimensions of the obtained sintered body were measured, the volume was calculated, and the weight of the sintered body was divided by the volume, thereby obtaining the sintered body density. Incidentally, the theoretical density of the shape dimensions was calculated, and then the ratio between the obtained sintered body density and the theoretical density was obtained and regarded as the relative density. The relative density can be obtained from (sintered body density/theoretical (density).

### (Evaluation of Impedance)

The obtained laminate was installed in a jig to which the laminate was fixed with a spring-loaded pin, and the internal resistance was measured using an Impedance/Gain-Phase analyzer. The measurement frequency was 0.005 Hz, and the AC applied voltage was 0.05 V in the measurement. The values of the obtained internal resistance are shown in Table 4. A case where the value of the internal resistance was smaller than 1×10⁷ (Ω) was evaluated as favorable.

### (Evaluation of Charge and Discharge Characteristics)

Furthermore, the obtained laminate was installed in the jig to which the laminate was fixed with a spring-loaded pin, and the charge and discharge capacity was measured using a charge and discharge tester. As the measurement conditions, the currents at the time of charging and discharging were all 2 μA, and the voltage was 0 V to 1.6 V in the measurement. The measured discharge capacities are shown in Table 4. A case where the value of the discharge characteristic was larger than 1.5 μAh was evaluated as favorable.

As is clear from Table 4, it is found that, for all-solid-state batteries in which the carbon material in a content within the scope according to the present invention is used for each of the positive electrode active material layer and the negative electrode active material layer, a dense sintered body can be obtained, and a low internal resistance is exhibited. In addition, it is found that, when the content of the carbon particles is 0.5 (wt %) or more and 15.0 (wt %) or less, a favorable discharge capacity can be obtained while a lower internal resistance is exhibited. In addition, it is found that, when the content of the carbon particles is 1.00 (wt %) or more and 15.0 (wt %) or less, a more favorable discharge capacity can be obtained while a lower internal resistance is exhibited.

TABLE 4

| | Average | | | | | | | | |
|---|---|---|---|---|---|---|---|---|---|
| | interplanar | | | | Prepared and | Residual | | Discharge | Relative |
| | spacing d002 | D10 | D90 | | added amount | content | Imp (Ω) at | capacity | density |
| | (nm) | (μm) | (μm) | a/b ratio | (wt %) | (wt %) | 0.005 Hz | (μAh) | (%) |
| Example 16 | 0.3365 | 0.25 | 4.5 | 3.0 | 0.49 | 0.43 | 9.75 × 10⁵ | 1.42 | 99.13 |
| Example 17 | 0.3365 | 0.25 | 4.5 | 3.0 | 0.58 | 0.51 | 4.58 × 10⁶ | 2.87 | 98.80 |
| Example 18 | 0.3365 | 0.25 | 4.5 | 3.0 | 1.13 | 1.00 | 9.94 × 10⁵ | 4.57 | 98.54 |
| Example 19 | 0.3365 | 0.25 | 4.5 | 3.0 | 7.12 | 6.30 | 6.87 × 10⁵ | 6.97 | 98.01 |
| Example 2 | 0.3365 | 0.25 | 4.5 | 3.0 | 11.30 | 10.00 | 5.15 × 10⁵ | 8.15 | 96.65 |
| Example 20 | 0.3365 | 0.25 | 4.5 | 3.0 | 16.95 | 15.00 | 1.33 × 10⁶ | 3.81 | 91.25 |
| Example 21 | 0.3365 | 0.25 | 4.5 | 3.0 | 18.08 | 16.00 | 1.35 × 10⁵ | 1.48 | 87.50 |

As described above, the all-solid-state battery according to the present invention is effective for a decrease in the internal resistance.

### REFERENCE SIGNS LIST

1 Positive electrode layer
2 Negative electrode layer
3 Solid electrolyte layer
4 Laminate
5, 6 Terminal electrode
10 All-solid-state battery

1. An all-solid-state battery comprising:
a positive electrode layer including a positive electrode current collector layer and a positive electrode active material layer;
a negative electrode layer including a negative electrode current collector layer and a negative electrode active material layer; and
a solid electrolyte layer containing a solid electrolyte,
wherein the positive electrode active material layer and the negative electrode active material layer contain carbon particles having an average interplanar spacing d002 of smaller than 0.342 (nm).

2. The all-solid-state battery according to claim 1,
wherein, in a case where a major axis of the carbon particle is indicated by a, and a minor axis is indicated by b, a ratio is 1.0<a/b.

3. The all-solid-state battery according to claim 1,
wherein, in a particle size distribution of the carbon particles, D10 is 0.1 μm or more, and D90 is 5.0 μm or less.

4. The all-solid-state battery according claim 1,
wherein the positive electrode active material layer and the negative electrode active material layer each contain 0.5 (wt %) or more and 15.0 (wt %) or less of the carbon particles.
